(19) United States
(12) Patent Application Publication
(10) Pub. No.: US 2006/0048520 A1
(43) Pub. Date: Mar. 9, 2006

(54) Cooling/heating pad

(75) Inventors: Bing-Chun Huang, Taipei (TW); Shen-Da Wu, Taipei (TW); Shueh-Cheng Lu, Taipei (TW)

Correspondence Address: BACON & THOMAS, PLLC, 625 SLATERS LANE, FOURTH FLOOR, ALEXANDRIA, VA, 22314, US

(73) Assignee: U-LONG CO., LTD., Taipei (TW)

(21) Appl. No.: 10/936,586

(22) Filed: Sep. 9, 2004

(51) Int. Cl. F25B 21/02; C10J 1/10; F24F 3/14; F02M 17/28; B01D 47/00; F25D 23/12

(52) U.S. Cl. 62/3.5; 62/259.3

(57) ABSTRACT

A cooling/heating pad of the present invention includes a pad portion, a water reservoir system and a heat exchanger, wherein the pad portion has the pad portion is a foldable, thin, double-layered bag and has a plurality of adhered regions formed by a hot-press or ultrasonic hot melting process to form the water channel between the adhered regions; the water reservoir system has a water reservoir and a water circulating pump, the water reservoir having a water inlet and a water outlet, the water inlet of the water reservoir connected to the water outlet of the water channel, and the water circulating pump moving the cooling water in the water reservoir from the water outlet of the water reservoir to the water inlet of the water channel; and the heat exchanger includes an electrical heating semiconductor chip, and a thermal conductor mounted on one side of the electrical heating semiconductor chip; wherein the thermal conductor directly contacts the cooling water in the water reservoir, or is mounted on a water path between the water outlet of the water reservoir to the water inlet of the water channel, so that the cooling water is capable of exchanging heat with the thermal conductor.

### BACKGROUND OF THE INVENTION

1. Field of the Invention

The present invention relates to a cooling/heating pad that may be applied to a local area and, more particularly, to a portable cooling/heating pad that can be used on beds, chairs or clothes.

2. Description of the Related Art

People who need to sit or lay down for long periods of time, such as drivers, office workers and paralyzed patients, may suffer discomfort because the portion of skin under pressure cannot easy disperse heat and evaporated sweat. As a solution, a cooling fan may be added under the mattress or seat pad to assist in the radiation of heat. However, this product is always pinched by the weight of the user, and the fan is a source of noise.

For paralyzed patients, to avoid bedsores and rashes, a mattress with an internal liquid filling can be heated or cooled by way of an electrical heater and Freon compressor cooler that respectively heat and cool the liquid. However, this mattress is too large to be portable, and is also noisy.

Furthermore, for people who spend time outdoors, especially police or soldiers, the requirement of wearing a uniform can be a source of suffering in temperature extremes.

A cooling/heating pad is disclosed in Taiwan patent No. 361249. As shown in FIG. 7, the pad comprises: an electronic cooling module (10), which generates a peltier effect after being subjected to a direct current; the electronic cooling module (10) is composed of a cold surface (101), which is capable of absorbing heat, and a hot surface (102), which is capable of radiating heat. When the direct current is reversed, the cold surface (101) changes to a radiator of heat, and the hot surface changes to an absorber of heat. A heat collector (11) is made of a good heat conducting material, and is adhered to the cold surface of the electronic cooling module (10); a winding channel (111) runs through the heat collector, and a water outlet (112) and a water inlet (113) are mounted on the heat collector (11). The water outlet and the water inlet are separately connected to a conduit (20); a pad (30) is connected to the heat collector (11) via the conduit (20). The pad utilizes a plurality of dividing blocks (31) to form a curved channel (32), so the heat collector, the conduit and the pad are all connected together and form a sealed space, which is filled with anti-freeze and a rust-preventative liquid (40); a pump (14) is connected to the conduit of the water outlet of the heat collector, and is used to move the liquid (40) from the heat collector (11) to the pad (30) so that the liquid can circulate within the heat collector, the conduit and the pad. A radiator (12) adhered to the hot surface (102) of the electronic cooling module (10) and a fan (15) are used for cooling.

Although, this prior art is an improvement on the drawbacks of large size and noise, it still suffers from problems; for example, most of the liquid (40) is in the pad (30), and a user may need to touch the pad(30) before it has reached the desired temperature, which can be uncomfortable. Furthermore, the pad (30) is heavy, and so cannot be used in clothing. Additionally, an insufficient amount of liquid in the heat collector (11) and the conduit (20) has a tendency to cause the pump (14) to break easily.

Therefore, it is desirable to provide a cooling/heating pad to mitigate and/or obviate the aforementioned problems.

### SUMMARY OF THE INVENTION

A main objective of the present invention is to provide a cooling/heating pad.

In order to achieve the above mentioned problems, a cooling/heating pad of the present invention comprises a pad portion, a water reservoir system and a heat exchanger, wherein the pad portion has the pad portion is a foldable, thin, double-layered bag and has a plurality of adhered regions formed by a hot-press or ultrasonic hot melting process to form the water channel between the adhered regions; the water reservoir system has a water reservoir and a water circulating pump, the water reservoir having a water inlet and a water outlet, the water inlet of the water reservoir connected to the water outlet of the water channel, and the water circulating pump moving the cooling water in the water reservoir from the water outlet of the water reservoir to the water inlet of the water channel; and the heat exchanger includes an electrical heating semiconductor chip, radiator fins disposed on one side of the electrical heating semiconductor chip, a radiator fan mounted outside of the radiator fins, and a thermal conductor mounted on an opposite side of the electrical heating semiconductor chip; wherein the thermal conductor directly contacts the cooling water in the water reservoir, or is mounted on a water path between the water outlet of the water reservoir to the water inlet of the water channel, so that the cooling water is capable of exchanging heat with the thermal conductor.

Preferably, a cooling water storage amount of the water reservoir is 1.5 to 4 times a cooling water storage amount of the water channel in the pad portion, and 2-3 times is the best. Therefore, there is enough water to keep the circulating water pump operating normally and to reduce the weight of the pad portion filled with cooling water. Furthermore, the cooling water in the present invention can be any well known cooling liquid.

The present invention provides smaller size and foldable pad. Furthermore, a hose coupler on the water inlet and the water outlet of the water channel of the pad portion, so the pad potion can be used along and connected to the pipe of the water reservoir portion and the heat exchange portion when the pad portion needs to be heated up or cooled down.

Other objects, advantages, and novel features of the invention will become more apparent from the following detailed description when taken in conjunction with the accompanying drawings.

### BRIEF DESCRIPTION OF THE DRAWINGS

FIG. 1 is a structural schematic drawing of the present invention.

FIG. 2 is an internal structural schematic drawing of a first embodiment according to the present invention.

FIG. 3 is an internal structural schematic drawing of a second embodiment according to the present invention.

FIG. 4 is a practical drawing of the present invention.

FIG. 5 is a structural schematic drawing of another embodiment according to the present invention.

FIG. 6 shows the present invention used on a cloth.

FIG. 7 shows a prior art cooling/heating pad.

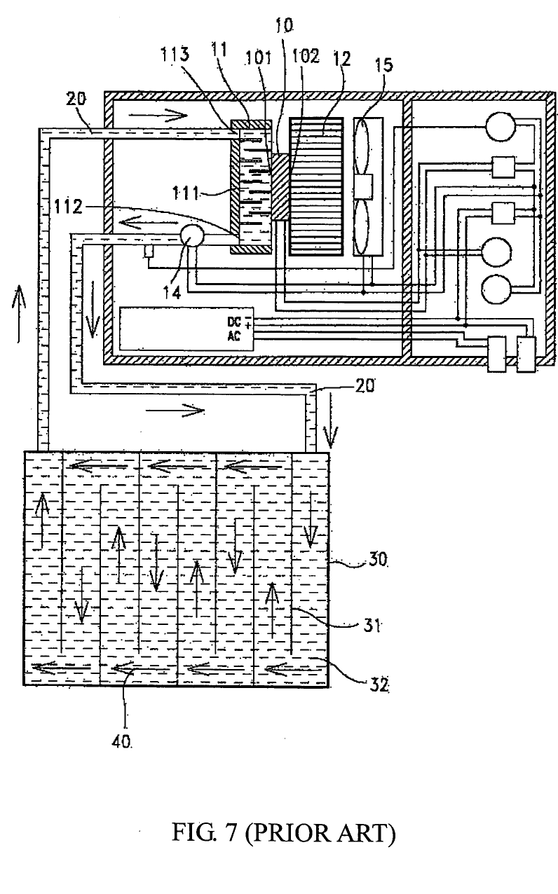

### DETAILED DESCRIPTION OF THE PREFERRED EMBODIMENTS

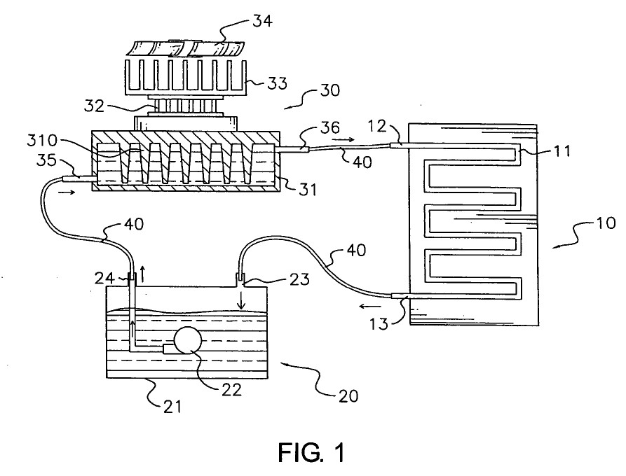

Please refer to FIG. 1. In a first embodiment of the present invention, a cooling/heating pad comprises a pad portion (10), a water reservoir system (20) and a heat exchanger (30). The pad portion (10) is a foldable, edge-sealed, thin, double-layered bag having an internal water channel (11), and the water channel (11) has a water inlet (12) and a water outlet (13).

The water reservoir system (20) has a water reservoir (21) and a water circulating pump (22). The water reservoir (21) has a water inlet (23) and a water outlet (24). The water outlet (24) is connected to the water outlet of the water circulating pump (22).

The heat exchanger (30) includes a water cooling cartridge (31), an electrical heating semiconductor chip (32) mounted on the water cooling cartridge (31), radiator fins (33) mounted on the electrical heating semiconductor chip (32), and a radiator fan (34) mounted outside of the radiator fins (33). The water cooling cartridge (31) has a thermal conductor (310), a water inlet (35) and a water outlet (36). In order to cool the water flowing in the cooling water cartridge (31), the thermal conductor (310) in the water cooling cartridge (31) conducts the heat from the flowing water to the electrical heating semiconductor chip (32) on the water cooling cartridge (31), and the radiator fan (34) and the radiator fins (33) radiate the heat; alternatively, the electrical heating semiconductor chip (32) can heat the water flowing in the water cooling cartridge (31). The pad portion (10), the water reservoir (21) of the water reservoir system (20) and the water cooling cartridge (31) of the heat exchanger portion (30) are connected together by a water circulating pipe (40). In this manner the cooling water is able to flow through the pad portion (10), the water reservoir system (20) and the heat exchanger (30).

In the first embodiment, the water in the water reservoir system is moved from the water outlet of the water reservoir along a water conduit of the water inlet of the water channel to the thermal conductor to exchange heat. First, the water circulating pump (22) of the water reservoir system (20) pumps the water to the cooling water cartridge (31) via the water circulating pipe (40) for heating or cooling, and then the water moves to the pad portion (10) via the water circulating pipe (40). Finally, the water circulates from the pad portion (10) back to the water reservoir (21) of the water reservoir system (20) via the water circulating pipe (40).

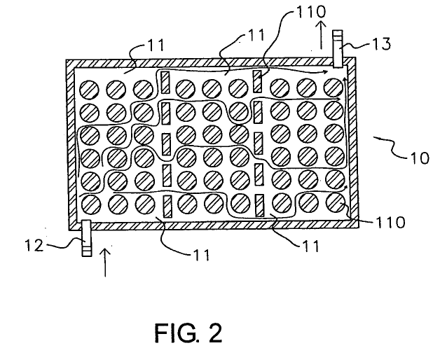

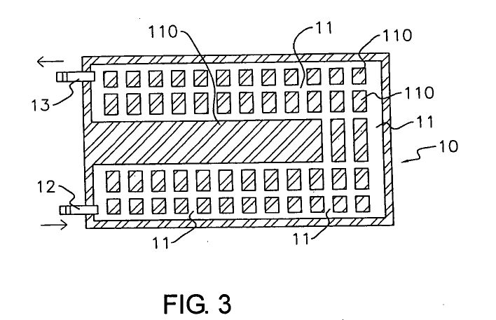

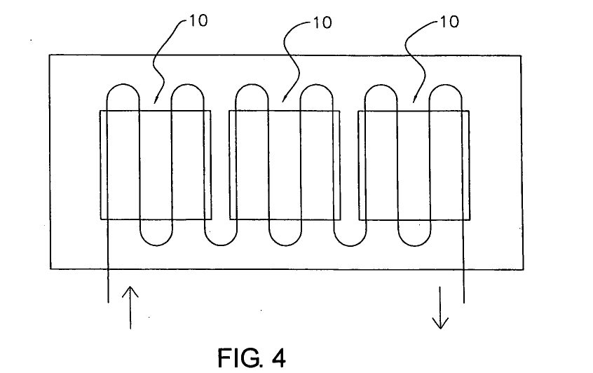

Please refer to FIG. 2 and FIG. 3. The pad portion (10) has a plurality of internal water channels (11), and the layout of the plurality of water channels provides for an even distribution on the pad portion (10). To form the water channels (11), the double-layered bag (10) has a plurality of adhered regions (110) formed by a hot-press or ultrasonic hot melting process to form the water channel (11) between the adhered regions. Please refer to FIG. 4. Several pad portions (10) can be combined together to provide a larger area.

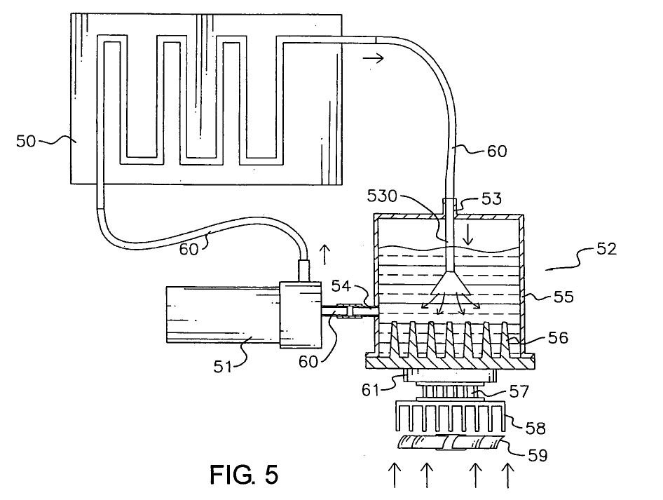

Please refer to FIG. 5. In another embodiment of the present invention, the water cooling cartridge and the water reservoir are combined. In this embodiment, the cooling/heating pad comprises a pad portion (50), a water circulating pump (51) and a heat exchanger (52). The pad portion (50) has a structure similar to the first embodiment, and the pad portion (50), the water circulating pump (51) and the heat exchanger (52) are connected together by a water circulating pipe (60). In this embodiment, the heat exchanger (52) has a cooling water reservoir (55) with a water inlet (53) and a water outlet (54), a thermal conductor (56) mounted in the cooling water reservoir (55), an electrical heating semiconductor chip (57) mounted outside of the cooling water reservoir (55), radiator fins (58) attached to the electrical heating semiconductor chip (57) and a radiator fan (59) mounted on the radiator fins (58). A conduit (530) can be mounted on the water inlet (53) of the cooling water reservoir (55) to disperse water onto the thermal conductor (56), and to enhance the thermal conductance, a pad block (61) can be mounted between the electrical heating semiconductor chip (57) and the thermal conductor (56).

In this embodiment, the water circulating pump (51) moves the water in the cooling water reservoir (55) to the pad portion (50), and then the water circulating pipe (60) sends the water in the pad portion (50) back to the cooling water reservoir (55). The heat exchanger (52) can heat or cool the water.

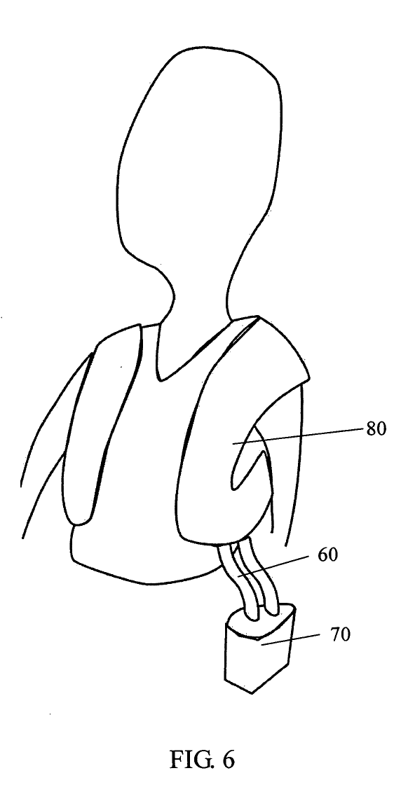

The cooling/heating pad of the present invention can not only be used on seats and mattresses, but also with clothing. As shown in FIG. 6, the water reservoir system and the heat exchanger are both placed in an external casing (70), and the pad portion is combined with a vest (80). When the water in the pad portion flows through the water circulating pipe (60) and the external casing (70), cooled or heated water will circulate.

Although the present invention has been explained in relation to its preferred embodiment, it is to be understood that many other possible modifications and variations can be made without departing from the spirit and scope of the invention as hereinafter claimed.

What is claimed is:

1. A cooling/heating pad comprising a pad portion, a water reservoir system and a heat exchanger, wherein
the pad portion has an internal water channel, the water channel having a water inlet and a water outlet;
the water reservoir system has a water reservoir and a water circulating pump, the water reservoir having a water inlet and a water outlet, the water inlet of the water reservoir connected to the water outlet of the water channel, and the water circulating pump moving the cooling water in the water reservoir from the water outlet of the water reservoir to the water inlet of the water channel; and
the heat exchanger includes an electrical heating semiconductor chip, radiator fins disposed on one side of the electrical heating semiconductor chip, a radiator fan mounted outside of the radiator fins, and a thermal conductor mounted on an opposite side of the electrical heating semiconductor chip; wherein the thermal conductor directly contacts the cooling water in the water reservoir, or is mounted on a water path between the water outlet of the water reservoir to the water inlet of the water channel, so that the cooling water is capable of exchanging heat with the thermal conductor.

2. The cooling/heating pad as claimed in claim 1, wherein the pad portion is a foldable, thin, double-layered bag.

3. The cooling/heating pad as claimed in claim 2, wherein the foldable, thin, double-layered bag has a plurality of adhered regions formed by a hot-press or ultrasonic hot melting process to form the water channel between the adhered regions.

4. The cooling/heating pad as claimed in claim 1, wherein the thermal conductor is mounted on a water path between the water outlet of the water reservoir to the water inlet of the water channel so that the cooling water is capable of exchanging heat with the thermal conductor.

5. The cooling/heating pad as claimed in claim 1, wherein the thermal conductor directly contacts the cooling water in the water reservoir.

6. The cooling/heating pad as claimed in one of claim 1, wherein a cooling water storage amount of the water reservoir is 1.5 to 4 times a cooling water storage amount of the water channel in the pad portion.

7. The cooling/heating pad as claimed in claim 6, wherein a cooling water storage amount of the water tank is 2 to 3 times a cooling water storage amount of the water channel in the pad portion.
